(19) United States
(12) Patent Application Publication
(10) Pub. No.: US 2009/0150914 A1
(43) Pub. Date: Jun. 11, 2009

(54) EXTERNAL OPTICAL DISK DRIVE

(75) Inventors: HE-LI WANG, Shenzhen City (CN); HONG LI, Shenzhen City (CN); TING ZHANG, Shenzhen City (CN); TING-TING ZHAO, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/239,825

(22) Filed: Sep. 29, 2008

(30) Foreign Application Priority Data
Dec. 7, 2007 (CN) 200710202926.9

(51) Int. Cl. G11B 7/00

(52) U.S. Cl. 720/692; G9B/7

(57) ABSTRACT

An external optical disk drive (99) includes a bottom housing (10), a top housing (20) coupled to the bottom housing, and a cover (40) pivotably connected to the top housing. The cover is provided with a hinge member (42). An engaging piece (424) is provided on the hinge member. A torsion spring (50) is biased between the top housing and the cover. A damping unit (32) is provided between the top housing and the bottom housing. When the cover is pivoted from a closed state to an open state, the engaging piece engages interferentially with the damping unit, and a frictional force is generated between the engaging piece and the damping unit to slow down a rotating speed of the cover to cause the cover to stop at the open state without vibration.

### BACKGROUND

1. Technical Field

The present invention relates to optical disk drives, and more particularly to an external optical disk drive with a locking mechanism for releasing or locking its cover.

2. Description of Related Art

Optical disk drives are becoming more popular in the market, and the optical disk drives may be considered as a standard or integral component of a personal computer. Generally speaking, optical disk drives are used to read or write information from/to optical disks. Examples of optical disk drives are compact disk drives (CD-ROM drives) and digital versatile disk drives (DVD-ROM drives) Optical disk drives are used in music and video playback and are implemented in recording devices and other electronic devices.

Conventional optical disk drives are categorized into two types: disk-tray optical disk drive and cover-lifting optical disk drive. Regarding the disk-tray type optical disk drive, optical disk can be placed on the disk tray when a disk tray motor drives the disk tray to a so called pull-out position. The cover-lifting type optical disk drive has an independent housing and is often referred as an external type optical disk drive. The external optical disk drive is coupled to a host computer via a signal cable to transmit data to the host computer. In addition, the external optical disk drive may transmit musical data to the users via an earphone cable.

In the prior art, a torsion spring is often adopted to eject the cover of the external optical disk drive from a closed state to an open state. Because the torsion spring is biased with a strong biasing force, the cover often vibrates uncontrollably and momentarily when the cover finally comes to the open state. In order to reduce vibration at the final stage when the cover is approaching the open state, a gear assembly is often adopted to slow down the rotating speed of the final stage. The gear assembly may include several spur gears meshed with each other. However, the provision of the gear assembly makes the system complex and greatly increases the cost of the final product.

What is needed, therefore, is an external optical disk drive with a simple structure and a low cost.

### SUMMARY

The present invention provides an external optical disk drive. According to an exemplary embodiment, the external optical disk drive includes a top housing, a bottom housing and a cover. The top housing defines a through hole. The bottom housing is coupled to the top housing. The cover is pivotably connected to the top housing. The cover is provided with a hinge member. The hinge member extends into the through hole of the top housing. An engaging piece is provided on the hinge member. A torsion spring is biased between the top housing and the cover. A damping unit is provided between the top housing and the bottom housing. When the cover is pivoted from a closed state to an open state, the engaging piece engages interferentially with the damping unit, and a frictional force is generated between the engaging piece and the damping unit to slow down a rotating speed of the cover to cause the cover to stop at the open state without vibration.

Other advantages and novel features of the present invention will become more apparent from the following detailed description of embodiments when taken in conjunction with the accompanying drawings.

### BRIEF DESCRIPTION OF THE DRAWINGS

FIG. 1 is an isometric view of an external optical disk drive in accordance with an embodiment of the present invention, with its cover at an open state.

FIG. 2 is an exploded, isometric view of the external optical disk drive of FIG. 1.

FIG. 3 is similar to FIG. 2, but shown in an inverted aspect.

FIG. 4 is an assembled, isometric view of the relevant components of the external optical disk drive of FIG. 3, with the cover at a closed state.

FIG. 5 is an assembled, isometric view of the relevant components of the external optical disk drive of FIG. 3, with the cover at an open state.

### DETAILED DESCRIPTION

Reference will now be made to the drawing figures to describe the embodiments in detail.

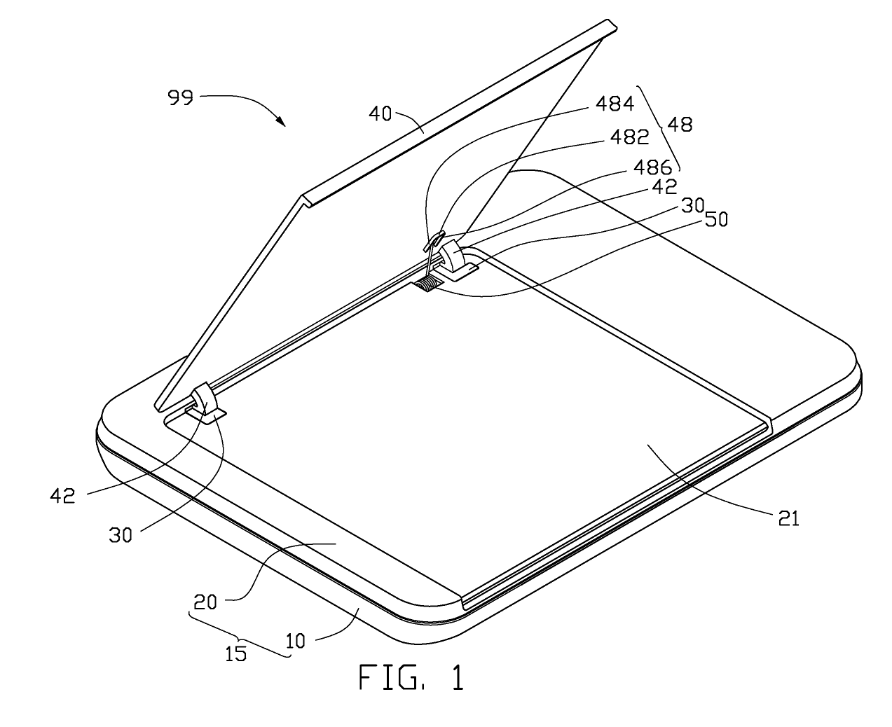

Referring to FIG. 1, an external optical disk drive 99 in accordance with an embodiment of the present invention is illustrated. The external optical disk drive 99 may be any type of external optical disk drives including, but not limited to, DVD-ROM drives, CD-ROM drives, as well as all other optical media recorders and players.

The external optical disk drive 99 includes a bottom housing 10, a top housing 20, and a cover 40. The top housing 20 is coupled to the bottom housing 10 to form a housing 15 with a hollow space being defined in the housing 15 for containing components of the external optical disk drive 99 therein. The cover 40 has a rectangular shape. The cover 40 has a front edge and a rear edge. The cover 40 is pivotally coupled to the top housing 20 with the rear edge of the cover 40 is hinged to a side and close to a rear edge of the top housing 20, so that the cover 40 can be pivotally rotated with respect to the top housing 20 and the bottom housing 10.

The external optical disk drive 99 is illustrated in FIG. 1 with the cover 40 opened. The top housing 20 is concaved downwardly with a containing space 21 defined between the cover 40 and the top housing 20. A playback unit is assembled in the containing space so as to read and/or write data. For simplicity, the playback unit is not shown in the illustrated embodiment, and the description about the playback unit is therefore omitted.

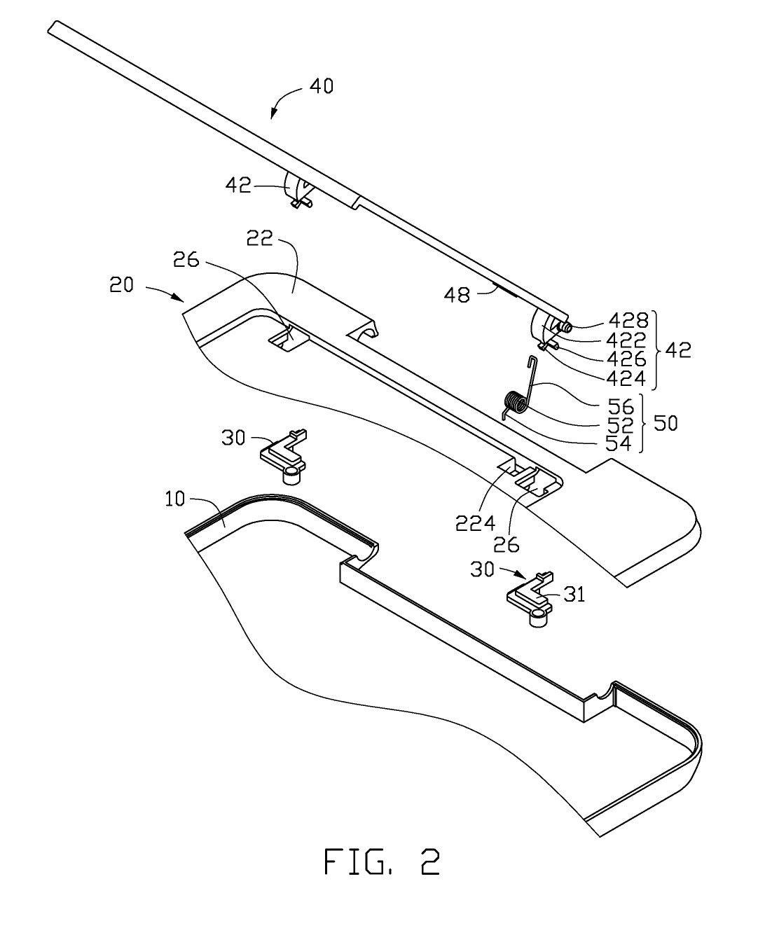

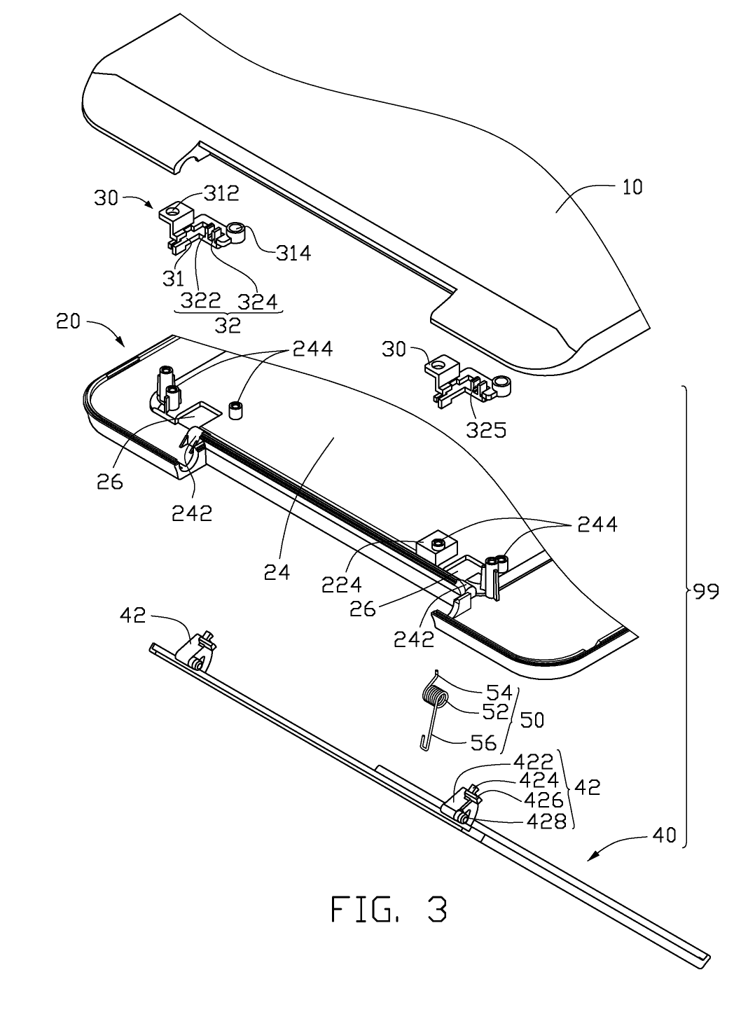

The external optical disk drive 99 adopts a locking mechanism for releasing and locking the cover 40 to the housing 15. FIGS. 2-3 best illustrate various components of the locking mechanism. The locking mechanism includes two damping seats 30, a torsion spring 50, and two hinge members 42.

The two hinge members 42 are integrally formed with the cover 40 and positioned at two opposite sides of the rear edge of the cover 40. Each hinge member 42 includes a sector-shaped main body 422, a first engaging piece 424, a second engaging piece 426, and a pivot shaft 428. The main body 422 is integrally connected with the cover 40. The first engaging piece 424 and the second engaging pieces 426 are perpendicular to each other, and extend integrally from the main body 422. The first engaging piece 424 extends from the main body 422 towards the damping seat 30. The second engaging piece 426 extends laterally from the main body 422. The pivot shaft 428 is aligned with a central axis of the sector-shaped main body 422 and is parallel to the second engaging piece 426.

The top housing 20 includes a top surface 22 and a bottom surface 24. The top surface 22 of the top housing 20 faces towards the cover 40. The bottom surface 24 of the top housing 20 faces towards the bottom housing 10. Two through holes 26 are defined through the top and the bottom surfaces 22, 24 of the top housing 20 at positions corresponding to the two hinge members 42 of the cover 40.

The top housing 20 is provided with a first spring support 224 for receiving part of the torsion spring 50 therein. The first spring support 224 is positioned adjacent to one of the through holes 26 of the top housing 20. In the illustrated embodiment, the first spring support 224 neighbors the through hole 26 that is defined at a right side of the top housing 20. The first spring support 224 is provided at the bottom surface 24 of the top housing 20, and has a concave depression concaved downwardly from the top surface 22 of the top housing 20 towards the bottom housing 10 for receiving part of the torsion spring 50 therein.

Referring back to FIG. 1, the cover 40 is provided with a second spring support 48. The second spring support 48 is positioned at a position corresponding to the first spring support 224. The second spring support 48 is utilized to mount the torsion spring 50. The second spring support 48 includes a first sidewall 482, a second sidewall 484, and a third sidewall 486. The first sidewall 482 is parallel to the rear edge of the cover 40. The second and the third sidewalls 484, 486 are parallel to each other and extend from opposite ends of the first sidewall 482 towards the rear edge of the cover 40.

The bottom surface 24 of the top housing 20 is provided with two receiving tubes 242 and four mounting sockets 244. Each of the receiving tubes 242 is positioned adjacent to a corresponding one of the through holes 26 of the top housing 20. Every two mounting sockets 244 form a group and are positioned at two opposite sides of a corresponding one of the through holes 26 of the top housing 20. The mounting sockets 244 are utilized to mount the damping seats 30 to the top housing 20. Each receiving tube 242 defines therein a pivot hole.

The torsion spring 50 is utilized to enable securing and opening of the cover 40. The torsion spring 50 includes a winding body 52, and first and second mounting arms 54, 56 respectively provided at free ends of the winding body 52. The first and the second mounting arms 54, 56 are provided to respectively engage with the first and the second spring supports 224, 48.

The damping seats 30 are mounted to the mounting sockets 244 of the top housing 20. Each damping seat 30 includes an L-shaped main body 31, two mounting holes 312, 314 provided at opposite sides of the main body 31, and a damping unit 32 extending perpendicularly from the main body 31 towards the bottom housing 10. The damping seats 30 are secured to the top housing 20 through fasteners such as screws extending through the mounting holes 312, 314 and engaged with the mounting sockets 244 of the top housing 20. The damping unit 32 includes a first damping tab 322 and a second damping tab 324. The first and the second damping tabs 322, 324 are parallel to each other and define a gap 325 therebetween.

In assembly, the damping seats 30 are mounted to the top housing 20. For example, screws may be used to extend through the mounting holes 312, 314 of the damping seats 30 and engage with the mounting sockets 244 of the top housing 20, thereby, securing the damping seats 30 to the top housing 20. The bottom housing 10 is coupled to the top housing 20. The hinge members 42 of the cover 40 extend into the through holes 26 of the top housing 20. The cover 40 then is laterally moved to cause the pivot shaft 428 of each hinge member 42 to enter into the pivot hole of a corresponding receiving tube 242, thereby pivotably mounting the cover 40 to the top housing 20. The first and the second mounting arms 54, 56 of the torsion spring 50 are respectively received in the first and the second spring supports 224, 48, to thereby bias the torsion spring 50 between the cover 40 and the top housing 20.

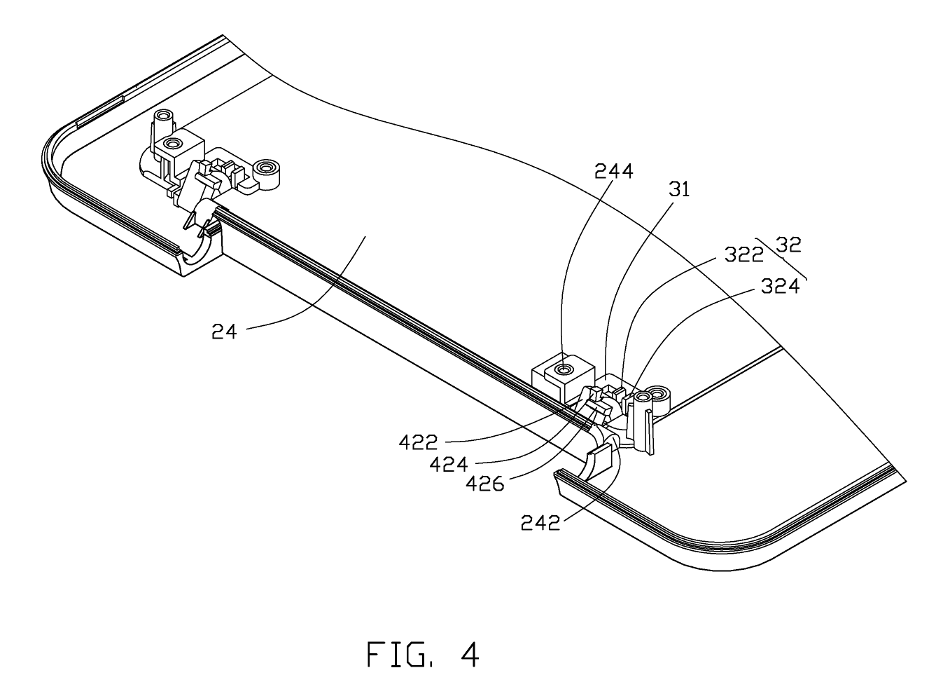

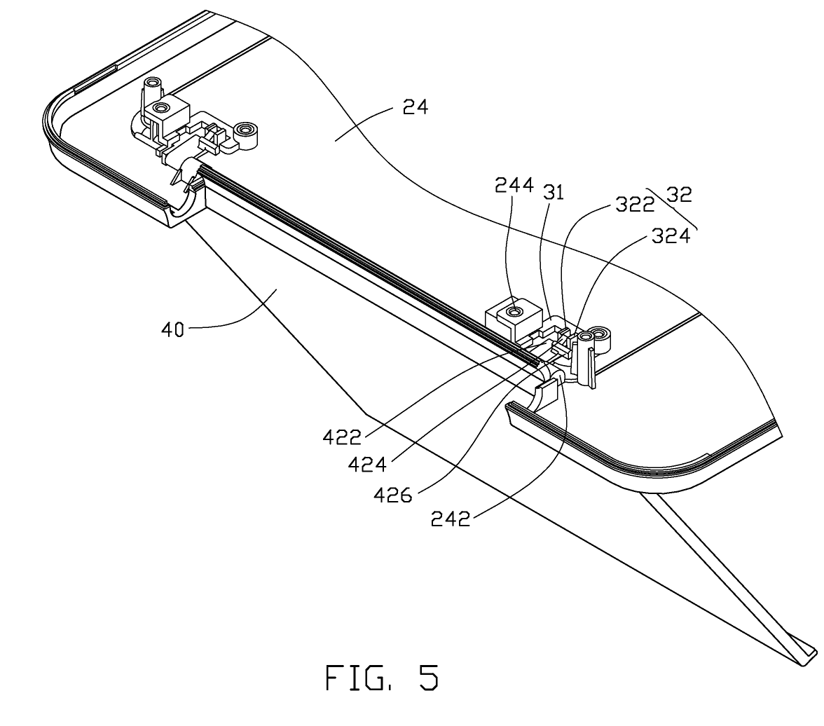

FIGS. 4-5 respectively illustrate the cover 40 in a closed state and in an open state. In the closed state as shown in FIG. 4, the cover 40 is locked with the housing 15 and the torsion spring 50 is biased. The cover 40 may be locked/latched to the housing 15. For example, a hook may be provided at the housing 15 that locks to the front edge of the cover 40, thereby locking the cover 40 to the housing 15. Furthermore, an ejection button may be provided on the housing 15 and used for unlatching the cover 40. When the ejection button is pressed, the cover 40 is released and ejected towards the open state as shown in FIG. 5.

When the ejection button is pressed to release/unlatch/unlock the cover 40 from the housing 15, the cover 40 is then ejected towards the open state under the elastic force of the torsion spring 50. When the cover 40 rotates from the closed state towards the open state, the cover 40 is pivotally rotated with respect to the top housing 20. After the cover 40 rotates to a particular angle, the first engaging pieces 424 of the hinge members 42 come into contact with the damping units 32 of the damping seats 30 correspondingly. The first engaging piece 424 of each hinge member 42 enters interferentially into the gap 325 defined between the first and the second damping tabs 322, 324 of the damping unit 32. Thus, a frictional force is generated between the first engaging piece 424 and the damping tabs 322, 324 to decelerate a rotating speed of the cover 40 when the cover 40 rotates to the final stage and approaches the fully opened state. When the first engaging piece 424 finally comes into contact with the main body 31 of the damping seat 30, the cover 40 is stopped at an opened position (i.e., the open state) without vibration. In the open state, the second engaging pieces 426 the hinge members 42 contact the bottom surface 24 of the top housing 20 to ensure that the cover 40 is stopped at the open state.

The existence of the engaging pieces 424, 426 and the damping tabs 322, 324 enables the cover 40 to pivot stably with respect to the housing 15 when the cover 40 rotates to the final stage and approaches the fully opened state. The external optical disk drive 99 does not require the gear assembly adopted in conventional arts to slow down the rotating speed of the cover 40, the structure is simplified and the cost is reduced effectively.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An external optical disk drive, comprising:
a top housing defining a through hole;
a bottom housing coupled to the top housing;
a cover pivotably connected to the top housing, the cover being provided with a hinge member, the hinge member extending into the through hole of the top housing, an engaging piece being provided on the hinge member;
a torsion spring biased between the top housing and the cover; and
a damping unit provided between the top housing and the bottom housing;
wherein when the cover is pivoted from a closed state to an open state, the engaging piece engages interferentially with the damping unit, and a frictional force is generated between the engaging piece and the damping unit to slow down a rotating speed of the cover to cause the cover to stop at the open state without vibration.

2. The external optical disk drive of claim 1, wherein the damping unit includes two parallel damping tabs, a gap is defined between the two damping tabs, and the engaging piece enters interferentially into the gap between the two damping tabs when the cover is pivoted from the closed state to the open state.

3. The external optical disk drive of claim 2, wherein a damping seat is provided between the top housing and the bottom housing, the two damping tabs extending from the damping seat.

4. The external optical disk drive of claim 3, wherein the damping seat is mounted to the top housing.

5. The external optical disk drive of claim 3, wherein the damping seat includes an L-shaped main body, the two damping tabs extending perpendicularly from the main body of the damping seat.

6. The external optical disk drive of claim 5, wherein the engaging piece contacts with the main body when the cover is stopped at the open state.

7. The external optical disk drive of claim 1, wherein the hinge member is provided with another engaging piece, and the another engaging piece contacts with the top housing when the cover is stopped at the open state.

8. An external optical disk drive, comprising:
a top housing defining a through hole;
a bottom housing coupled to the top housing;
a cover pivotably connected to the top housing, the cover being provided with a hinge member, the hinge member extending into the through hole of the top housing, an engaging piece being provided on the hinge member, the cover being capable of rotating between a closed state and an open state;
a torsion spring biased between the top housing and the cover; and
means for slowing a rotating speed of the cover as the cover rotates from the closed state towards the open state.

9. The external optical disk drive of claim 8, wherein said means for slowing the rotating speed of the cover includes a damping unit, the engaging piece engages interferentially with the damping unit when the cover rotates from the closed state towards the open state, and a frictional force is generated between the engaging piece and the damping unit to slow down the rotating speed of the cover.

10. The external optical disk drive of claim 9, wherein the damping unit includes two damping tabs, a gap is defined between the two damping tabs, and the engaging piece enters interferentially into the gap between the two damping tabs when the cover rotates from the closed state towards the open state.

11. The external optical disk drive of claim 10, wherein a damping seat is provided between the top housing and the bottom housing, the two damping tabs extending from the damping seat.

12. The external optical disk drive of claim 11, wherein the damping seat is mounted to the top housing.

13. The external optical disk drive of claim 11, wherein the damping seat includes an L-shaped main body, the two damping tabs extending perpendicularly from the main body.

14. The external optical disk drive of claim 9, wherein the hinge member includes a sector-shaped main body, the engaging piece extending from the main body towards the damping unit.

15. The external optical disk drive of claim 14, wherein the hinge member is provided with another engaging piece, and the another engaging piece contacts with the top housing when the cover is stopped at the open state.

16. The external optical disk drive of claim 9, wherein the top housing is provided with a first spring support, the cover is provided with a second spring support, and the torsion spring is biased between the first spring support and the second spring support.
